(19) United States
(12) Patent Application Publication
(10) Pub. No.: US 2008/0019832 A1
(43) Pub. Date: Jan. 24, 2008

(54) TURBINE/ROTORCRAFT/OAR BLADE

(76) Inventor: Thomas Anderson, Bellport, NY (US)

Correspondence Address: MICHAEL RIES, 318 PARKER PLACE, OSWEGO, IL, 60543, US

(21) Appl. No.: 11/775,818

(22) Filed: Jul. 10, 2007

Related U.S. Application Data
(60) Provisional application No. 60/819,915, filed on Jul. 10, 2006.

(51) Int. Cl. B64C 11/06; F03D 3/00

(52) U.S. Cl. 416/117; 416/132 B; 416/140

(57) ABSTRACT

The present invention generally relates to the field of blades that may be rotating, with a design producing maximum drag when encountering air/water flow in one direction, and either minimum drag, in the power generating application, or maximum lift in the rotorcraft application when encountering air/water flow in the opposite direction.

This application claims the benefit of U.S. Provisional Patent Application Ser. No. 60/819,915, filed Jul. 10, 2006.

### TECHNICAL FIELD & BACKGROUND

The present invention generally relates to the field of blades that when rotating produce maximum drag when encountering air/water flow in one direction, and either minimum drag, in the power generating application, or maximum lift in the rotorcraft application when encountering air/water flow in the opposite direction.

Present state-of-the art wind and water powered generating systems require a massive support tower, at least half as high as their diameter, and require a system to position the rotor disc perpendicular to the wind/water flow. This design places the generator atop the support tower at the horizontal axis of rotation; a maintenance headache. Existing water/windmill powered generators employ this costly, intrusive design, using rotating airfoil shaped blades to produce lift to power an electric generator.

The present invention utilizes a design producing maximum drag when encountering air/water flow in one direction, and either minimum drag, in the power generating application, or maximum lift in the rotorcraft application when encountering air/water flow in the opposite direction. These blade designs are a new direction in wind/watermill and rotorcraft design.

Relevant to electric power generation, the minimum drag blade, allows positioning the rotation axis vertically, significantly reducing the height of the support structure and allows the generator to be housed at ground level. Additionally the blade design operates with wind or water flow from any direction (i.e. omni directional), eliminating the need to rotate the entire structure to face the wind/water flow. Because the length of its blades has little affect on its height it is visually less objectionable.

In water applications (i.e. rivers, streams, inlets or the Gulf Stream), the generator may be fixed or anchored to the seabed with the rotor disc below boat traffic. For ease of maintenance and to negate operating a generator below sea level, it may also be on a floating platform tethered to the seabed, with the rotor disc safely beneath maritime traffic.

In rotorcraft applications, particularly gyrocopters, the maximum lift blade allows gyrocopters to operate with higher angles of attack. This would produce the same lift from a smaller disc diameter with shorter stronger blades. In a rigid rotor helicopter application, under power, it would act as a standard blade, but unpowered (i.e. power failure) it would auto-rotate instantly upon losing power.

### BRIEF DESCRIPTION OF THE DRAWINGS

The present invention will be described by way of exemplary embodiments, but not limitations, illustrated in the accompanying drawings in which like references denote similar elements, and in which:

FIG. 1 illustrates a side view of generator 10, in accordance with one embodiment of the present invention

FIG. 2 illustrates a top view of rotating blades, in accordance with one embodiment of the present invention

FIG. 3 illustrates a drawing of a side view of a double blade set generator, in accordance with one embodiment of the present invention

FIG. 4 illustrates a drawing of a perceptive view of the first blade set, in accordance with one embodiment of the present invention

FIG. 5 illustrates a drawing of a side view of the first blade set, in accordance with one embodiment of the present invention

FIG. 6 illustrates a drawing of a side view of the leading edge, in accordance with one embodiment of the present invention

FIG. 7 illustrates a drawing of the fixed leading edge, in accordance with one embodiment of the present invention

FIG. 8 illustrates a drawing a top view of many blades, in accordance with one embodiment of the present invention

FIG. 9 illustrates a drawing of a rotorcraft blade in a first position and second position, in accordance with one embodiment of the present invention

FIG. 10 illustrates a drawing of a side view of rotorcraft, in accordance with one embodiment of the present invention

FIG. 11 illustrates a drawing of a top view of rotorcraft rotating blades, in accordance with one embodiment of the present invention

FIG. 12 illustrates a drawing of a side view of a fixed leading edge, in accordance with one embodiment of the present invention

FIG. 13 illustrates a drawing of a top view of two rotorcraft blades, in accordance with one embodiment of the present invention

FIG. 14 illustrates a drawing of a side view of kayak paddle, in accordance with one embodiment of the present invention

FIG. 15 illustrates a drawing of a side view of a boat oar, in accordance with one embodiment of the present invention

### DETAILED DESCRIPTION OF ILLUSTRATIVE EMBODIMENTS

Various aspects of the illustrative embodiments will be described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations are set forth in order to provide a thorough understanding of the illustrative embodiments. However, it will be apparent to one skilled in the art that the present invention may be practiced without the specific details. In other instances, well-known features are omitted or simplified in order not to obscure the illustrative embodiments.

Various operations will be described as multiple discrete operations, in turn, in a manner that is most helpful in understanding the present invention; however, the order of description should not be construed as to imply that these operations are necessarily order dependent. In particular, these operations need not be performed in the order of presentation.

The phrase “in one embodiment” is used repeatedly. The phrase generally does not refer to the same embodiment, however, it may. The terms “comprising”, “having” and “including” are synonymous, unless the context dictates otherwise.

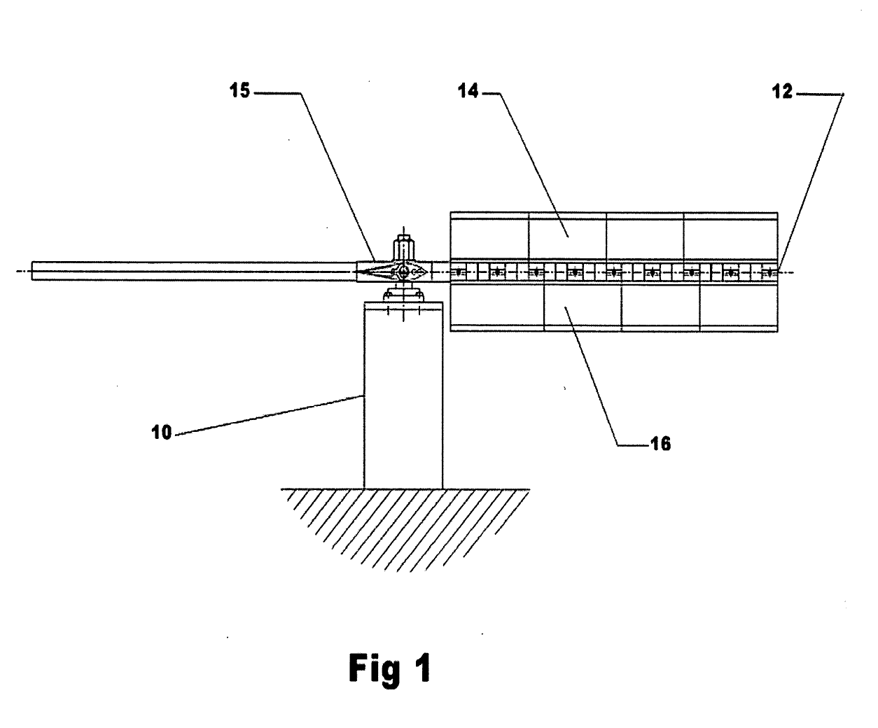

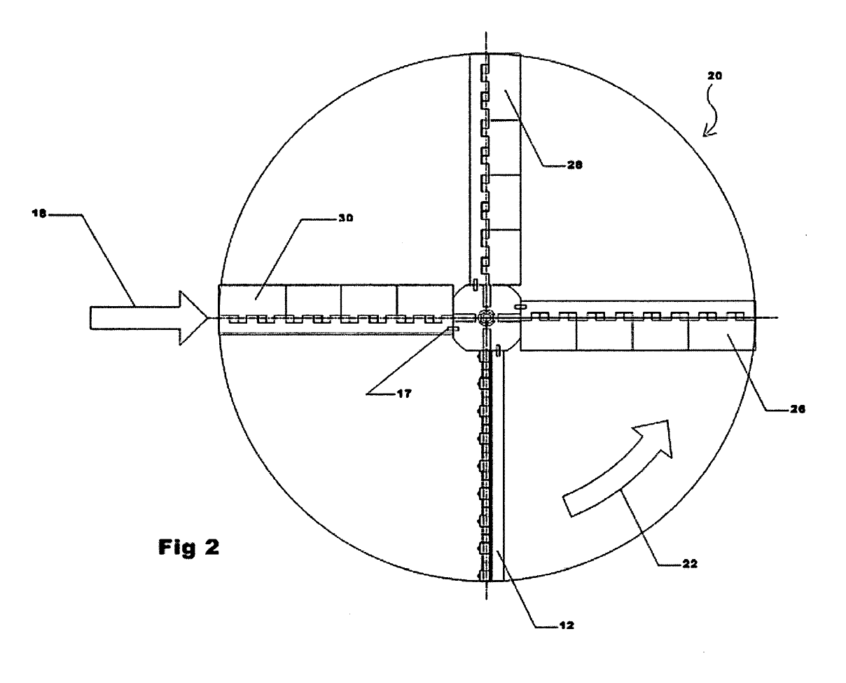

Now referring to FIG. 1, as in one embodiment of the present invention, is a side view of generator 10. A first blade set 12 is shown with first blades 14 upper and second blades 16 lower in an open position or as shown in a horizontal orientation engaging a fluid such as wind or water. Shown is rotor hub 15 and governor controlled speed release pin 17 for wind applications. Referring to FIG. 2 as in one embodiment of the present invention, shown is a top view of rotating blades 20 with a wind or water direction 18. A rotation direction 22 shows a counterclockwise direction. First blade set 12 engage wind from wind direction 18 by first blades 14 turning up stopping in a up position and second blades 16 turning down stopping in a down position, both first and second blades are in a vertical position. As the rotating blades 20 move a second blade set 26, third blade set 28 and forth blade set 30 will be in a horizontal position. Each of the second blade set 26, third blade set 28 and forth blade 30 will in turn as the rotating blades 10 rotate move in a down and up position engaging the wind like first blade set 12.

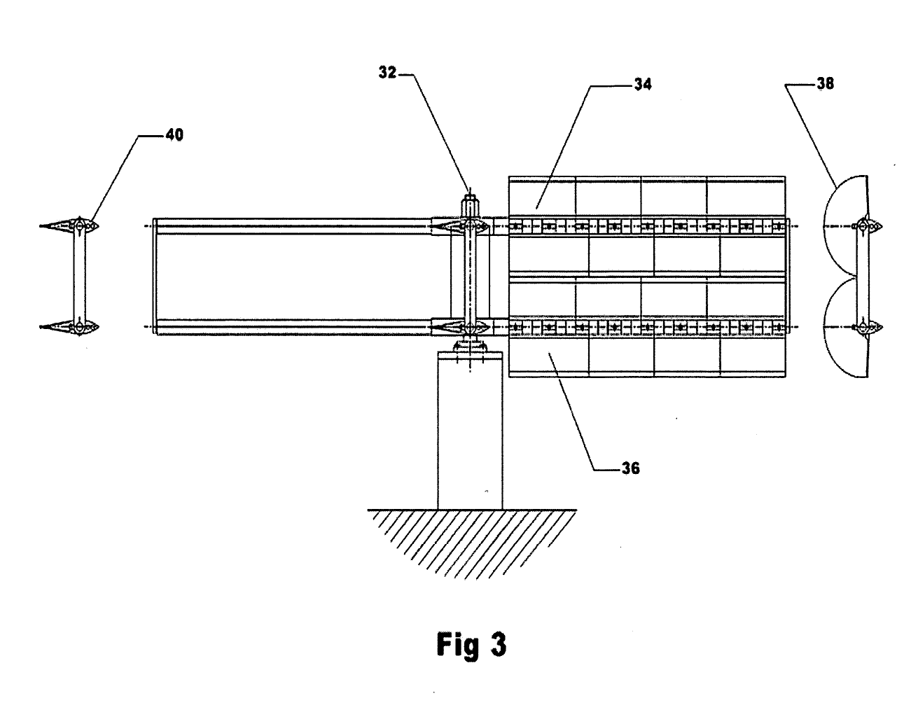

Referring to FIG. 3 as in one embodiment of the present invention, shown is a side view of a double blade set generator 32. Shown is upper blade set 34 and lower blade set 36. Shown in end view 38 is both upper blade set 34 and lower blade set 36 in vertical positions engaging the water or wind. Shown in end view 40 is both upper blade set 34 and lower blade set 36 in horizontal positions not engaging the water or wind.

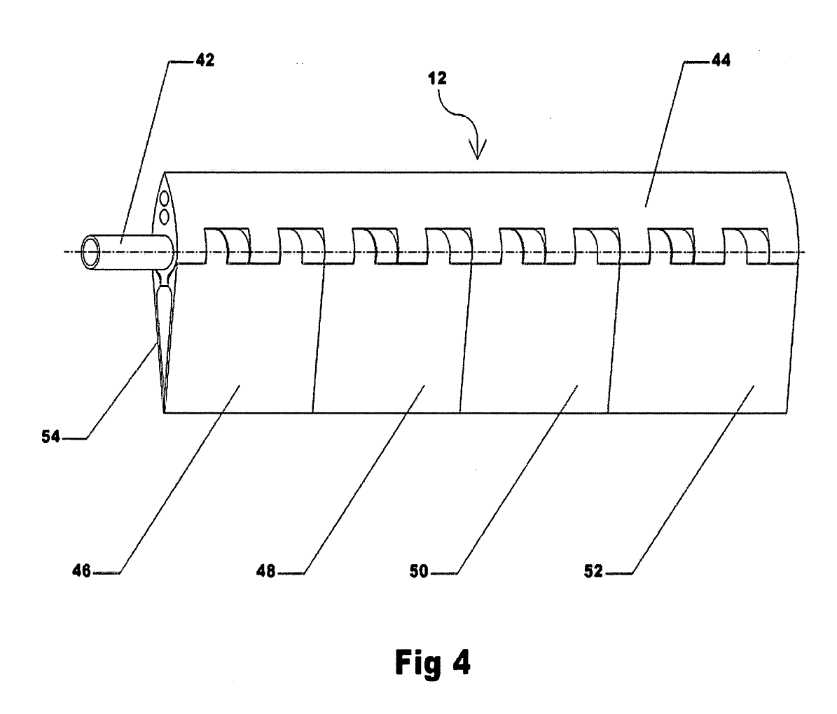

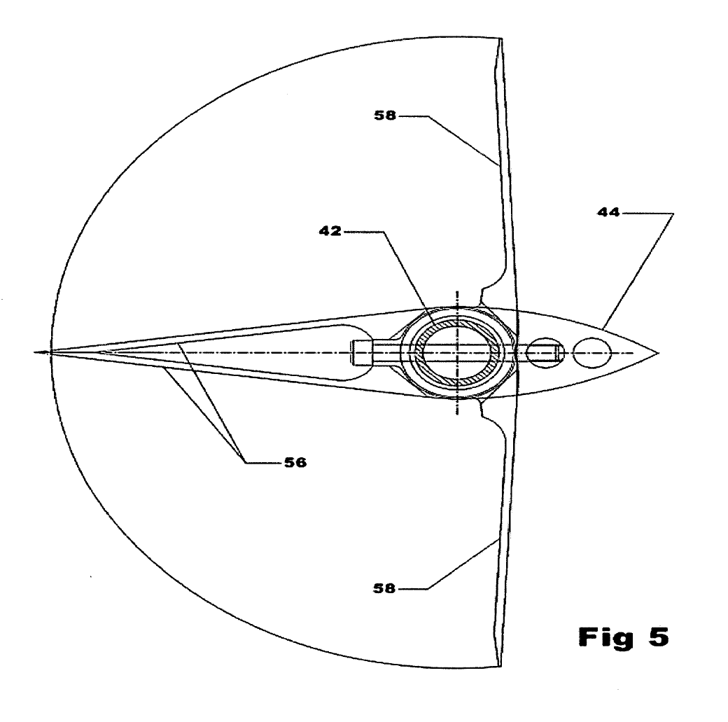

Referring to FIG. 4 as in one embodiment of the present invention, shown is a perceptive view of the first blade set 12 with a main support shaft 42, that may be a steel tube, inside a fixed leading edge 44 attaching main support shaft 44 to a first blade 46, a second blade 48 , a third blade 50 , a forth blade 52 and a fifth blade 54. Referring to FIG. 5 as in one embodiment of the present invention, shown is a side view of the first blade set 12. Shown is the main support shaft 42 with fixed leading edge 44. A closed position 56 of the first blade 46 and the fifth blade 54 is shown. An open position 58 of the first blade 46 and the fifth blade 54 is shown.

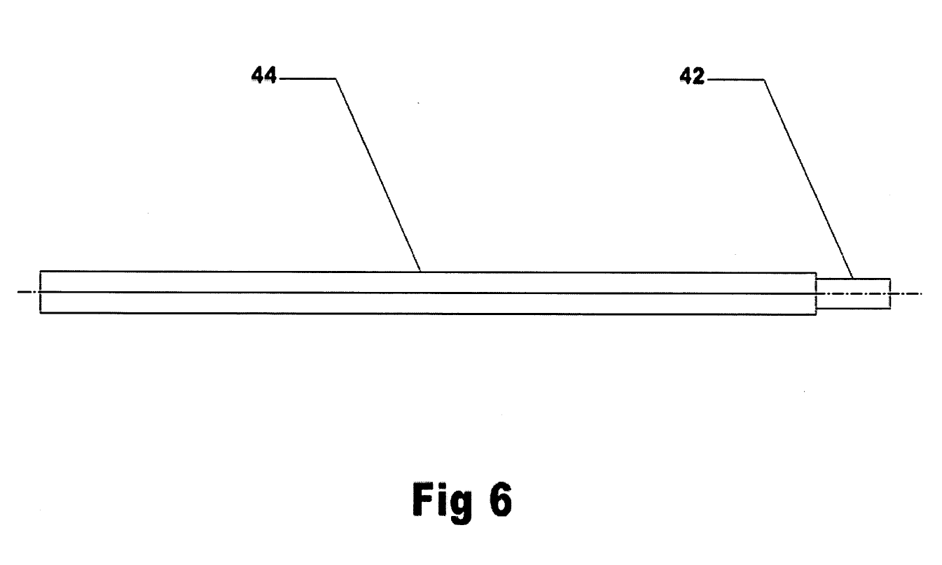

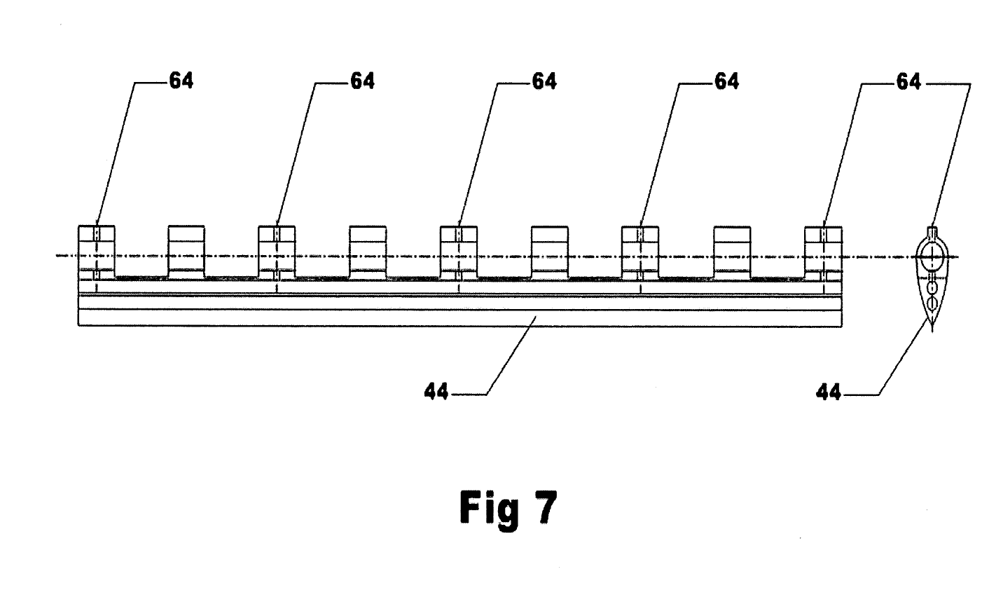

Referring to FIG. 6 as in one embodiment of the present invention, shown is a side view of the main support shaft 42 and fixed leading edge 44. Referring to FIG. 7 as in one embodiment of the present invention, shown is a side view of the fixed leading edge 44 with a plurality of blade attachment holes 64. Each of the plurality of blade attachment holes 64 will be used for attaching the fixed leading edge to the main support shaft 42.

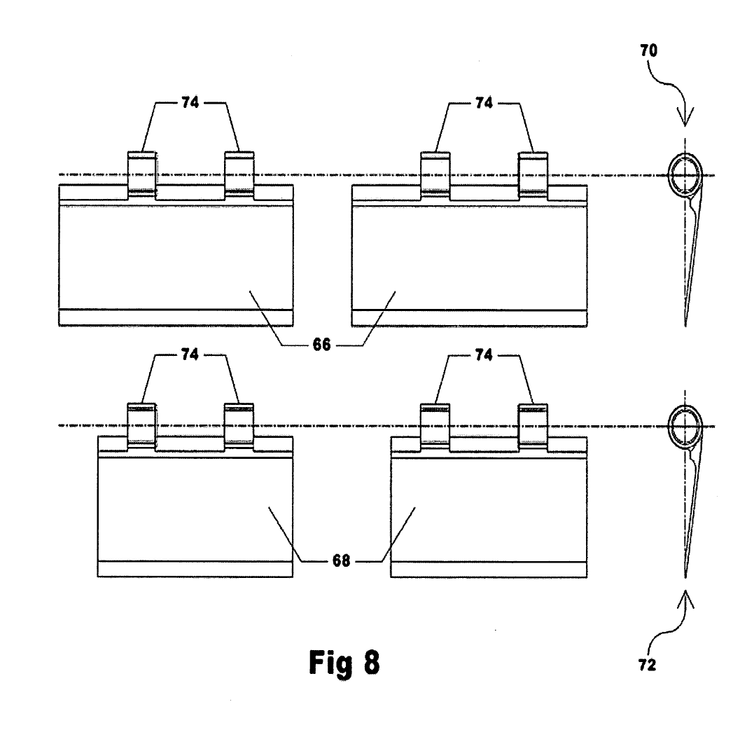

Referring to FIG. 8 as in one embodiment of the present invention, shown is a top view of many blades. Blades will come in a first size 66 and a second size 68. Shown is an end view 70 of the first size 66. Shown is an end view 72 of the second size 68. A plurality of blade attachment hinge lugs 74 are shown. The plurality of blade attachment hinge lugs 74 nest together along side each other and inside a space between consecutive blade attachment hinge lugs 64 (FIG. 7). Each blade will have 2 bearings inside the attachment hinge lugs 64 that oscillate on the main support shaft 42. The oscillating trailing edges, flaps or blades are segmented, with two (2) hinge lugs per segment. This is to eliminate any binding when the main support shaft and fixed leading edges flex due to loads while in operation.

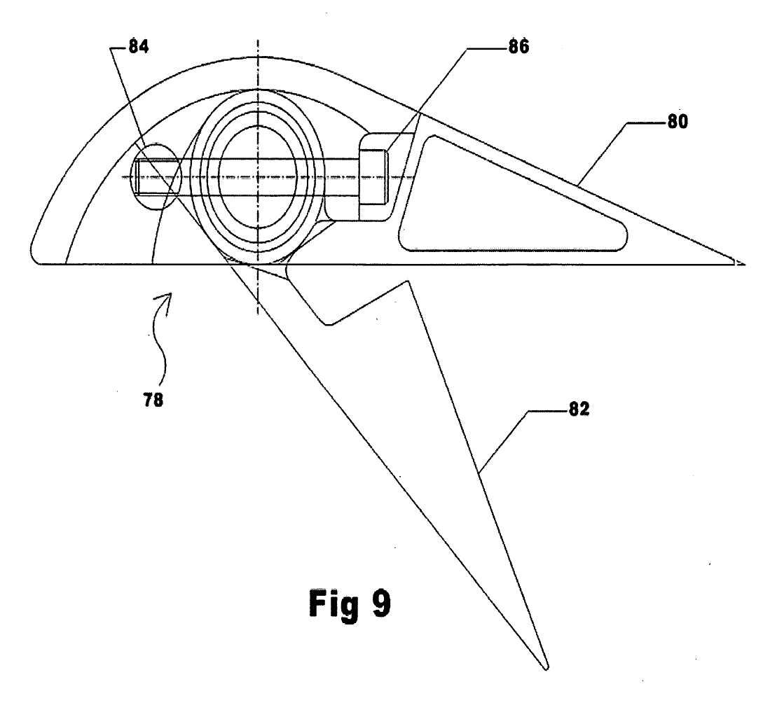

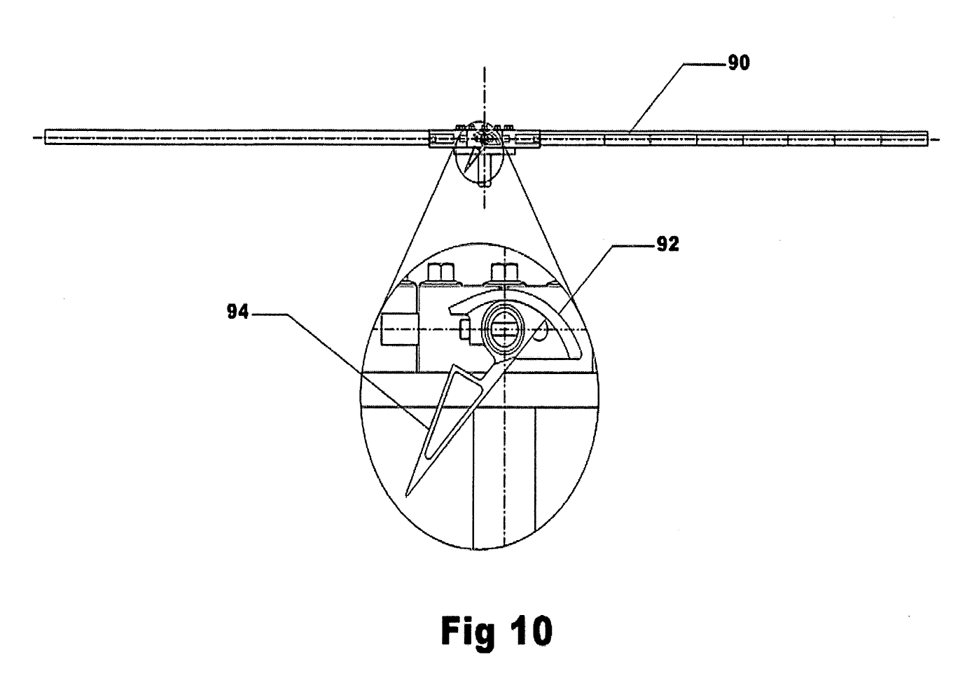

Referring to FIG. 9 as in one embodiment of the present invention, shown is a rotorcraft blade 78 in a first position 80 and second position 82. A barrel nut 84 is attached to cap screw 86 securing the rotorcraft fixed leading edge to the main support shaft. Referring to FIG. 10, as in one embodiment of the present invention, is a side view of rotorcraft 90. A first blade rotorcraft set 92 is shown with rotorcraft blades 94 in an open position or as shown in position to engage the wind or airflow.

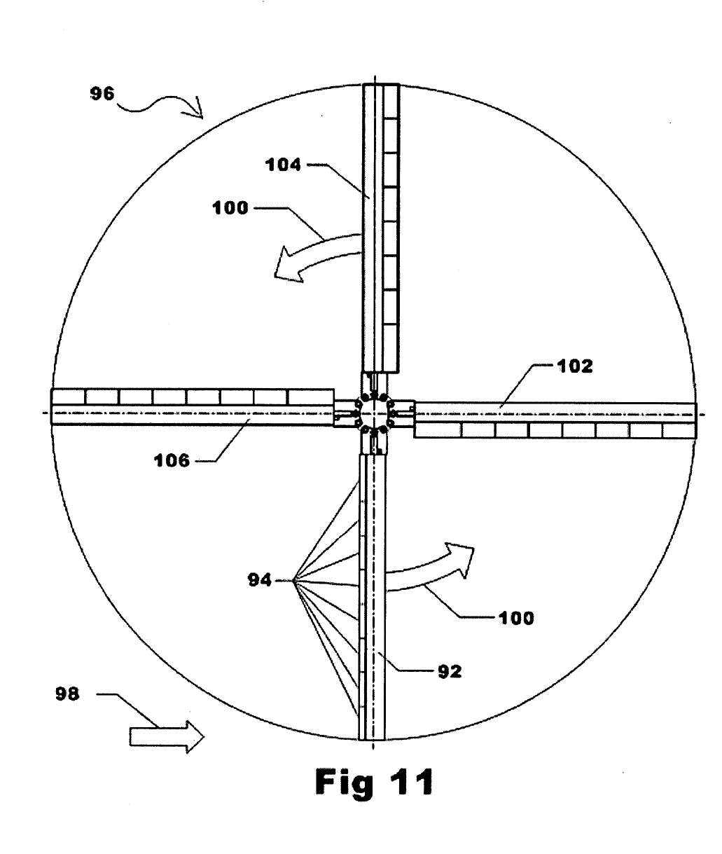

Referring to FIG. 11 as in one embodiment of the present invention, shown is a top view of rotorcraft rotating blades 96 with an air flow 98. A rotation direction 100 shows a counterclockwise direction. The first rotorcraft blade set 92 engage air flow 98 by the first rotorcraft blades 94 turning down stopping in a approximately forty five degree angle from the horizontal. As the rotating blades 96 move a second rotorcraft blade set 102, third rotorcraft blade set 104 and forth rotorcraft blade set 106 will be in a horizontal position.

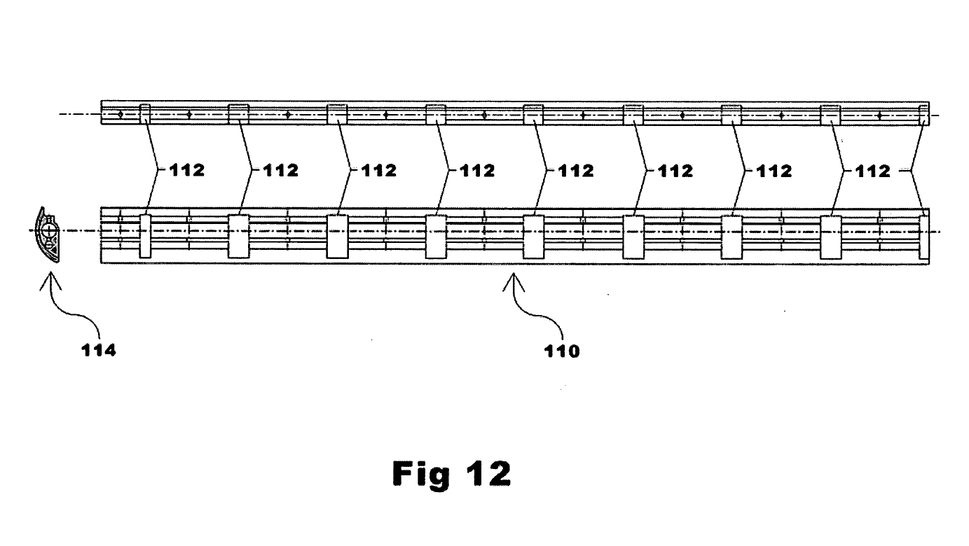

Referring to FIG. 12 as in one embodiment of the present invention, shown is a side view of a fixed leading edge 110 with a plurality of rotorcraft blade attachments 112. Each of the plurality of rotorcraft blade attachments or slots 112 will support a bearing for attachment of one of the rotorcraft blades. Shown is a side view 114 of fixed leading edge 110.

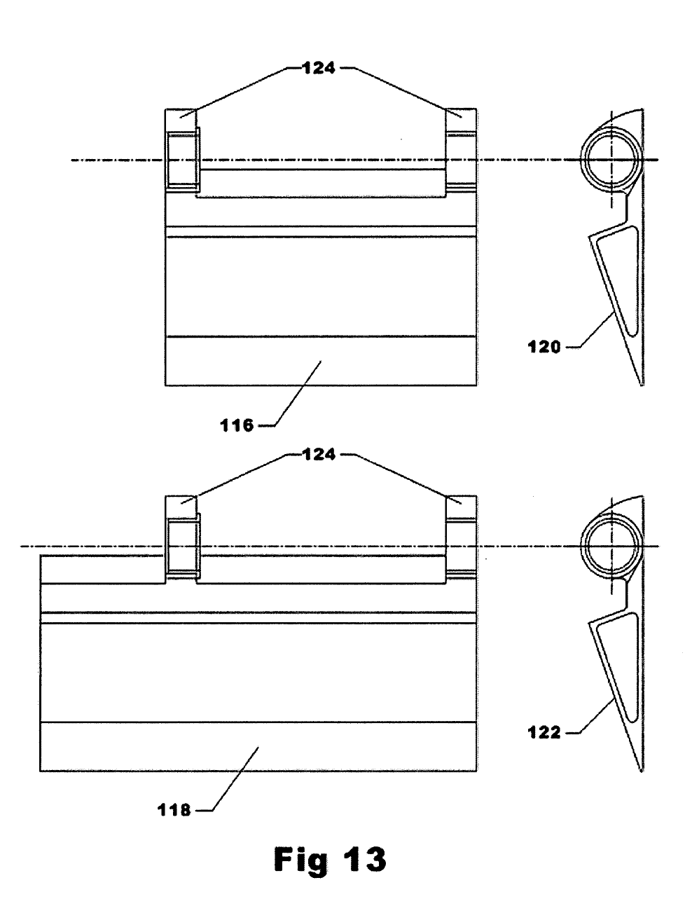

Referring to FIG. 13 as in one embodiment of the present invention, shown is a top view of two rotorcraft blades. Rotorcraft blades will come is a first rotorcraft size 116 and a second rotorcraft size 118. Shown is an end view 1 20 of the first rotorcraft size 116. Shown is an end view of 122 of the second rotorcraft size 118. A plurality of rotorcraft blade attachment tabs 124 are shown. The plurality of rotorcraft blade attachment tabs 124 nest together along side each other and inside a space between consecutive rotorcraft blade attachments or slots 112. Each rotorcraft blade will have two bearings inside the rotorcraft attachment tabs, for example IGUS IGLIDE brand bearings that are made of plastic. The oscillating trailing rotorcraft edges, rotorcraft flaps or rotorcraft blades are segmented, with two (2) rotorcraft hinge lugs per segment. This is to eliminate any binding when the rotorcraft main support shaft and rotorcraft fixed leading edges flex due to loads while in operation.

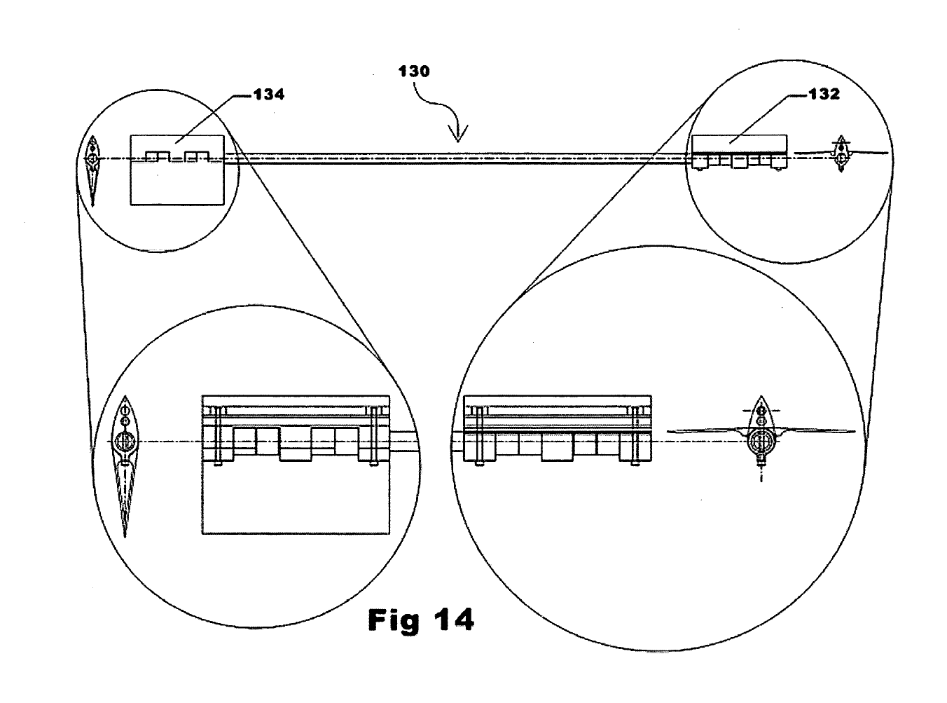

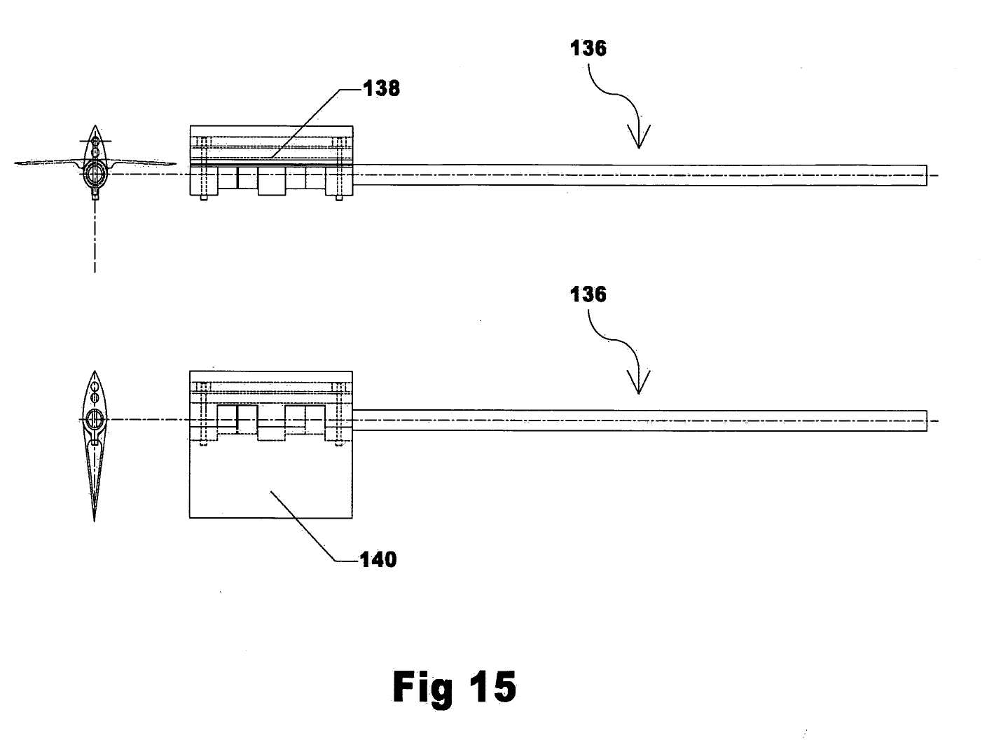

Referring to FIG. 14 as in one embodiment of the present invention, shown is a top view of a kayak paddle 130. A first kayak paddle 132 is vertical engaging the water and a second paddle 134 is horizontal moving across the top of a water surface. Referring to FIG. 15 as in one embodiment of the present invention, shown is a top view of a boat oar 136. A first boat oar paddle 138 is vertical engaging the water and a second boat oar paddle 140 is horizontal moving across the top of a water surface.

While the present invention has been related in terms of the foregoing embodiments, those skilled in the art will recognize that the invention is not limited to the embodiments depicted. The present invention can be practiced with modification and alteration within the spirit and scope of the appended claims. Thus, the description is to be regarded as illustrative instead of restrictive on the present invention.

What is claimed is:

1. A rotating blade comprising:
a shaft;
at least one blade that will oscillate on the shaft; and
a stop that will position the blade to produce maximum drag when encountering fluid flow in one direction, the blade having minimum drag when encountering fluid flow in the opposite direction.

2. The rotating blade of claim 1 wherein the rotating blade is on a generator the generator has at least one blade set, the blade set has at least one upper blade and at least one lower blade both upper and lower blades move to an open position engaging the fluid flow and a closed position when not engaging a fluid flow.

3. The rotating blade of claim 1 wherein a first blade set engage wind from a wind direction by the first blades turning up stopping in an up position and second blades turning down stopping in a down position, both first and second blades are in a vertical position, as the rotating blades move a second blade set, third blade set and forth blade set will be in a horizontal position, each of the second blade set, third blade set and forth blade will in turn as the rotating blades rotate move in a down and up position engaging the wind like the first blade set.

4. The rotating blade of claim 1 wherein a first blade set with a main support shaft is inside a fixed leading edge attaching the main support shaft to a first blade, a second blade, a third blade, a forth blade and a fifth blade.

5. The rotating blade of claim 4 wherein the main support shaft is a steel tube.

6. The rotating blade of claim 4 wherein the fixed leading edge has a plurality of blade attachment holes, each of the plurality of blade attachment holes attaches the fixed leading edge to the main support shaft.

7. The rotating blade of claim 1 wherein the at least one blade will come is a first size and a second size.

8. The rotating blade of claim 1 wherein each blade has a plurality of blade attachment hinge lugs, the plurality of blade attachment hinge lugs nest together along side each other and inside a space between consecutive blade attachment hinge lugs, each blade will have bearings inside the attachment hinge lugs that provide oscillation on when attached to the main support shaft.

9. A rotatable blade comprising:
a shaft;
a blade that oscillate on the shaft; and
a stop on the shaft for the blade that will produce maximum drag when encountering fluid flow in one direction and maximum lift in a rotorcraft when encountering fluid flow in the opposite direction.

10. The rotating blade of claim 9 wherein the rotating blade is on a generator the generator has at least one blade set, the blade set has at least one upper blade and at least one lower blade both upper and lower blades move to an open position engaging the fluid flow and a closed position when not engaging a fluid flow.

11. The rotating blade of claim 9 wherein a first blade set engage wind from a wind direction by the first blades turning up stopping in an up position and second blades turning down stopping in a down position, both first and second blades are in a vertical position, as the rotating blades move a second blade set, third blade set and forth blade set will be in a horizontal position, each of the second blade set, third blade set and forth blade will in turn as the rotating blades rotate move in a down and up position engaging the wind like the first blade set.

12. The rotating blade of claim 9 wherein a first blade set with a main support shaft is inside a fixed leading edge attaching the main support shaft to a first blade, a second blade, a third blade, a forth blade and a fifth blade.

13. The rotating blade of claim 9 wherein the main support shaft is a steel tube.

14. The rotating blade of claim 12 wherein the fixed leading edge has a plurality of blade attachment holes, each of the plurality of blade attachment holes attaches the fixed leading edge to the main support shaft.

15. The rotating blade of claim 9 wherein the at least one blade will come is a first size and a second size.

16. The rotating blade of claim 9 wherein each blade has a plurality of blade attachment hinge lugs, the plurality of blade attachment hinge lugs nest together along side each other and inside a space between consecutive blade attachment hinge lugs, each blade will have bearings inside the attachment hinge lugs that provide oscillation on when attached to the main support shaft.

17. An oscillating blade comprising;
a fixed leading edge with a plurality of attachment lugs, a fixed leading edge connected to a rotor hub;
a main support shaft inside the fixed leading edge; and
at least one blade with a plurality of attachment holes the blade attached to the main support shaft and the fixed leading edge by the attachment lug and attachment holes aligned so that the main support shaft can pass through both the attachment lugs and attachment holes while the main support shaft is inside the fixed leading edge.

18. The oscillating blade of claim 17 wherein the fixed leading edge will have a stop to position the blade at a predetermined oscillation angle.

19. The oscillating blade of claim 17 wherein each blade will have a stop to position the blade at a predetermined oscillation angle.

20. The oscillating blade of claim 19 wherein the predetermined oscillation angle is a selected one of approximately four five degrees from the horizontal and approximately ninety degrees from the horizontal.
